(19) United States
(12) Patent Application Publication
(10) Pub. No.: US 2022/0023957 A1
(43) Pub. Date: Jan. 27, 2022

(54) Sheet Metal Tooling Assembly

(71) Applicant: Angel Botello, Phoenix, AZ (US)

(72) Inventor: Angel Botello, Phoenix, AZ (US)

(21) Appl. No.: 16/936,117

(22) Filed: Jul. 22, 2020

(51) Int. Cl. B23B 31/107; B23Q 1/01

(52) U.S. Cl. CPC B23B 31/1071; B23B 2231/44; B23Q 1/015

(57) ABSTRACT

A sheet metal tooling assembly for drilling, snipping, notching, and crimping sheet metal includes a housing, which defines an interior space. A motor and a drive linkage are engaged to the housing and are positioned in the interior space. The drive linkage is operationally engaged to the motor. A battery is selectively engageable to the first section so that the battery is operationally engaged to the motor. A fixed chuck is engaged to the housing and is operationally engaged to the drive linkage. A tool for tooling sheet metal is selectively engageable to the fixed chuck. The motor is positioned to actuate the tool via the drive linkage and the shaft so that the tool can effect tooling of the sheet metal.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tooling assemblies and more particularly pertains to a new tooling assembly for drilling, snipping, notching, and crimping sheet metal.

### (2) Description of Related Art Including Information Disclosed Under 37 CFR 1.97 and 1.98

The prior art relates to tooling assemblies. Prior art tooling assemblies may comprise powered cutting or crimping tools, and hand tools for crimping and shearing.

### BRIEF SUMMARY OF THE INVENTION

An embodiment of the disclosure meets the needs presented above by generally comprising a housing, which defines an interior space. A motor and a drive linkage are engaged to the housing and are positioned in the interior space. The drive linkage is operationally engaged to the motor. A battery is selectively engageable to the first section so that the battery is operationally engaged to the motor. A fixed chuck is engaged to the housing and is operationally engaged to the drive linkage. A tool is selectively engageable to the fixed chuck and is configured for tooling sheet metal. The motor is positioned to actuate the tool via the drive linkage and the shaft so that the tool is configured to effect tooling of the sheet metal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a sheet metal tooling assembly according to an embodiment of the disclosure.

FIG. 2 is an exploded view of an embodiment of the disclosure.

FIG. 3 is a partial bottom view of an embodiment of the disclosure.

FIG. 4 is a cross-sectional view of an embodiment of the disclosure.

FIG. 5 is a kit view of an embodiment of the disclosure.

### DETAILED DESCRIPTION OF THE INVENTION

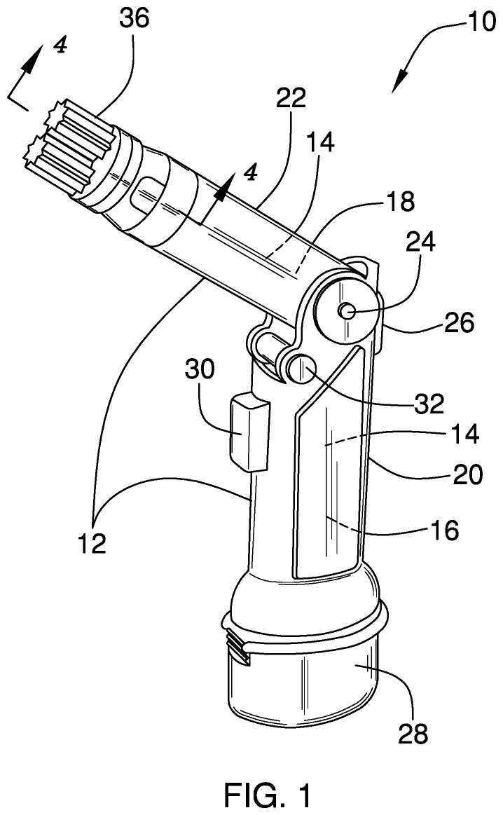

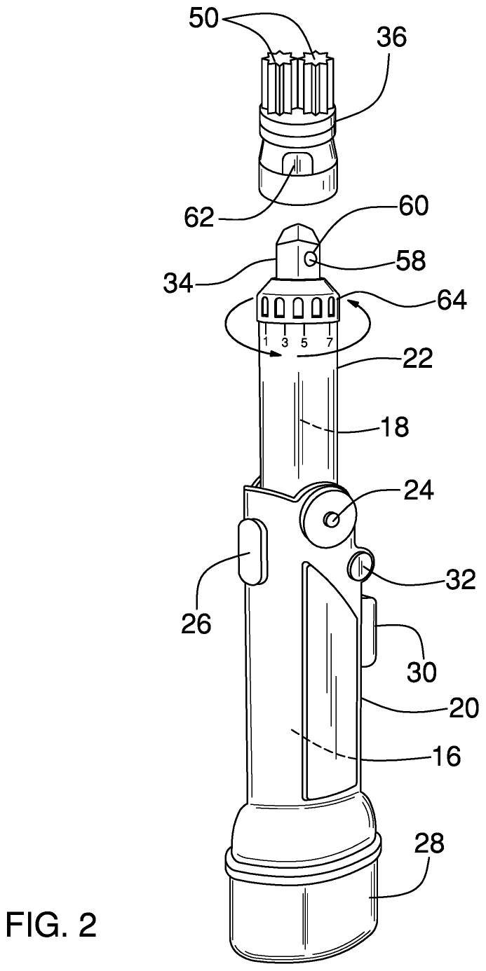

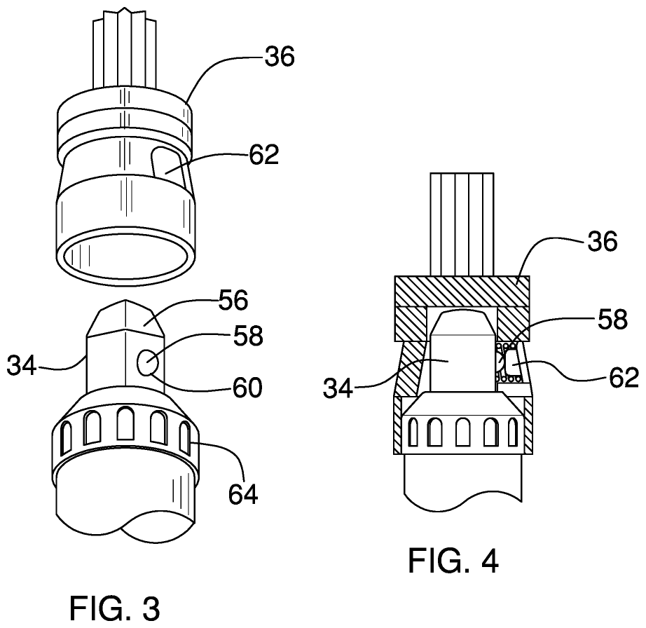

With reference now to the drawings, and in particular to FIGS. 1 through 5 thereof, a new tooling assembly embodying the principles and concepts of an embodiment of the disclosure and generally designated by the reference numeral 10 will be described.

As best illustrated in FIGS. 1 through 5, the sheet metal tooling assembly 10 generally comprises a housing 12, which defines an interior space 14. A motor 16 and a drive linkage 18 are engaged to the housing 12 and are positioned in the interior space 14. The drive linkage 18 is operationally engaged to the motor 16. The housing 12 comprises a first section 20 hingedly engaged to a second section 22. The motor 16 is positioned in the first section 20. The drive linkage 18 is positioned in the second section 22.

A pivot 24 is operationally engaged to the first section 20 and the second section 22 so that the second section 22 is selectively pivotable relative to the first section 20. A button 26 is engaged to the first section 20 proximate to the second section 22 and is selectively engageable to the pivot 24 to fixedly position the second section 22 relative to the first section 20. The button 26 is spring-loaded so that the button 26 is configured to be depressed to disengage the button 26 from the pivot 24 so that the second section 22 is pivotable relative to the first section 20.

A battery 28 is selectively engageable to the housing 12 so that the battery 28 is operationally engaged to the motor 16. The battery 28 may be engageable to the first section 20, as shown in FIG. 1. The battery 28 is rechargeable.

A trigger 30 is engaged to the housing 12 and is operationally engaged to the motor 16 and the battery 28. The trigger 30 is configured to be selectively depressed to engage the battery 28 to the motor 16 to supply power thereto. A switch 32 is engaged to the housing 12 and is operationally engaged to the motor 16. The switch 32 is configured to be selectively switched to select between forward and reverse rotation of the motor 16.

A fixed chuck 34 is engaged to the housing 12 and is operationally engaged to the drive linkage 18. A tool 36 is selectively engageable to the fixed chuck 34 and is configured for tooling sheet metal. The motor 16 is positioned to actuate the tool 36 via the drive linkage 18 and the shaft so that the tool 36 is configured to effect tooling of the sheet metal.

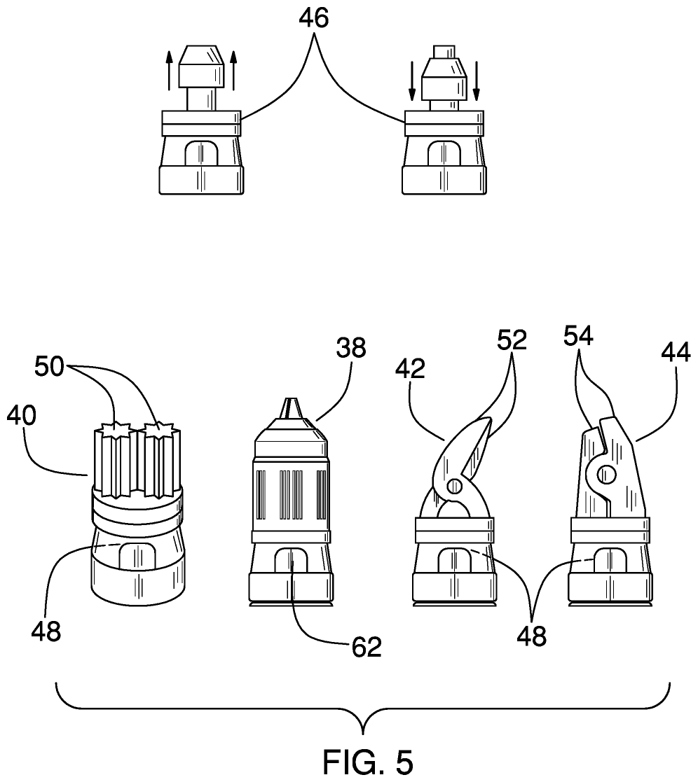

The tool 36 is one of a plurality of tools 36, as shown in FIG. 5. Each tool 36 of the plurality of tools 36 has a respective metal working function so that the plurality of tools 36 comprises tools 36 having a variety of metal working functions.

The plurality of tools 36 may comprise an adjustable chucking device 38, a crimping device 40, a snipping device 42, a notching device 44, and a release head 46. The adjustable chucking device 38 is configured to engage a respective one of a plurality of bits (not shown). The present invention anticipates the plurality of tools 36 comprising other metal working implements, such as, but not limited to, sanding discs, grinding discs, and the like.

The crimping device 40 comprises a rotation translator 48, which is configured to translate rotation of the fixed chuck 34 into counter rotation of a pair of crimper rods 50 so that the crimping device 40 is configured to crimp the sheet metal.

The snipping device 42 also comprises a rotation translator 48, which is configured to translate rotation of the fixed chuck 34 into counter movement of a pair of shears 52 so that the snipping device 42 is configured to snip the sheet metal.

The notching device 44 also comprises a rotation translator 48, which is configured to translate rotation of the fixed chuck 34 into counter movement of a pair of notching arms 54 so that the notching device 44 is configured to notch the sheet metal.

The release head 46 is selectively engageable to the fixed chuck 34 and is configured to selectively engage a hexagonal shaft of an implement (not shown), thereby rendering the assembly 10 compatible with additional implements for tooling sheet metal.

The fixed chuck 34 comprises a square shaft 56 and a pin 58, which is engaged to and which extends perpendicularly from the square shaft 56. The pin 58 is spring loaded so that the pin 58 is selectively depressible into a recess 60 extending into the square shaft 56. A knob 62 is engaged to the tool. The knob 62 is spring loaded and is configured to be selectively depressed so that the knob 62 pushes the pin 58 into the recess 60, allowing the tool 36 to be removed from the fixed chuck 34.

A torque selector 64 is rotationally engaged to the housing 12 and is operationally engaged to the motor 16 and the drive linkage 18. The torque selector 64 is configured to be rotated to select a torque to be applied by the motor 16 to the drive linkage 18.

In use, a tool 36 from the plurality of tools 36 appropriate to a desired sheet metal tooling need is selected and attached to the fixed chuck 34. An appropriate angle of the second section 22 to the first section 20 of the housing 12 is obtained by first depressing the button 26 and then pivoting the second section 22 relative to the first section 20. Upon release of the button 26, the second section 22 is fixedly positioned relative to the first section 20. The trigger 30 is depressed to actuate the motor 16, causing the drive linkage 18 to rotate the fixed chuck 34 so that the tool 36 is configured to effect the desired tooling of the sheet metal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A sheet metal tooling assembly comprising:
a housing defining an interior space;
a motor engaged to the housing and positioned in the interior space;
a drive linkage engaged to the housing and positioned in the interior space, the drive linkage being operationally engaged to the motor;
a battery selectively engageable to the housing such that the battery is operationally engaged to the motor;
a fixed chuck engaged to the housing and being operationally engaged to the drive linkage; and
a tool selectively engageable to the fixed chuck, the tool being configured for tooling sheet metal, such that the motor is positioned for actuating the tool via the drive linkage and the shaft, wherein the tool is configured for effecting tooling of the sheet metal.

2. The sheet metal tooling assembly of claim 1, further including:
the housing comprising a first section hingedly engaged to a second section, the motor being positioned in the first section, the drive linkage being positioned in the second section;
a pivot operationally engaged to the first section and the second section such that the second section is selectively pivotable relative to the first section;
a button engaged to the first section proximate to the second section and being selectively engageable to the pivot for fixedly positioning the second section relative to the first section, the button being spring-loaded; wherein the button is configured for depressing for disengaging the button from the pivot such that the second section is pivotable relative to the first section;

3. The sheet metal tooling assembly of claim 1, wherein the battery is rechargeable.

4. The sheet metal tooling assembly of claim 1, further including a trigger engaged to the housing and being operationally engaged to the motor and the battery, wherein the trigger is configured for selectively depressing for engaging the battery to the motor for powering the motor.

5. The sheet metal tooling assembly of claim 1, further including a switch engaged to the housing and being operationally engaged to the motor, wherein the switch is configured for selectively switching for selecting forward and reverse rotation of the motor.

6. The sheet metal tooling assembly of claim 1, wherein the tool is one of a plurality of tools, each tool of the plurality of tools having a respective metal working function such that the plurality of tools comprises tools having a variety of metal working functions.

7. The sheet metal tooling assembly of claim 6, wherein the plurality of tools comprises an adjustable chucking device wherein the adjustable chucking device is configured for engaging a respective one of a plurality of bits.

8. The sheet metal tooling assembly of claim 6, wherein the plurality of tools comprises a crimping device, the crimping device comprising a rotation translator configured for translating rotation of the fixed chuck into counter rotation of a pair of crimper rods, wherein the crimping device is configured for crimping the sheet metal.

9. The sheet metal tooling assembly of claim 6, wherein the plurality of tools comprises a snipping device, the snipping device comprising a rotation translator configured for translating rotation of the fixed chuck into counter movement of a pair of shears, wherein the snipping device is configured for snipping the sheet metal.

10. The sheet metal tooling assembly of claim 6, wherein the plurality of tools comprises a notching device, the notching device comprising a rotation translator configured for translating rotation of the fixed chuck into counter movement of a pair of notching arms, wherein the notching device is configured for notching the sheet metal.

11. The sheet metal tooling assembly of claim 6, wherein the plurality of tools comprises a release head selectively engageable to the fixed chuck, wherein the release head is configured for selectively engaging a hexagonal shaft of an implement.

12. The sheet metal tooling assembly of claim 1, further including:
the fixed chuck comprising a square shaft and a pin, the pin being engaged to and extending perpendicularly from the square shaft, the pin being spring loaded such that the pin is selectively depressible into a recess extending into the square shaft; and
a knob engaged to the tool, the knob being spring loaded such that the knob is configured for selectively depressing such that the knob pushes the pin into the recess allowing the tool to be removed from the fixed chuck.

13. The sheet metal tooling assembly of claim 1, further including a torque selector rotationally engaged to the housing and being operationally engaged to the motor and the drive linkage, wherein the torque selector is configured for rotating for selecting a torque applied by the motor to the drive linkage.

14. A sheet metal tooling assembly comprising:
a housing defining an interior space, the housing comprising a first section hingedly engaged to a second section;
a motor engaged to the housing and positioned in the interior space, the motor being positioned in the first section;
a drive linkage engaged to the housing and positioned in the interior space, the drive linkage being operationally engaged to the motor, the drive linkage being positioned in the second section;
a pivot operationally engaged to the first section and the second section such that the second section is selectively pivotable relative to the first section;
a button engaged to the first section proximate to the second section and being selectively engageable to the pivot for fixedly positioning the second section relative to the first section, the button being spring-loaded; wherein the button is configured for depressing for disengaging the button from the pivot such that the second section is pivotable relative to the first section;
a battery selectively engageable to the housing such that the battery is operationally engaged to the motor, the battery being rechargeable;
a trigger engaged to the housing and being operationally engaged to the motor and the battery, wherein the trigger is configured for selectively depressing for engaging the battery to the motor for powering the motor;
a switch engaged to the housing and being operationally engaged to the motor, wherein the switch is configured for selectively switching for selecting forward and reverse rotation of the motor;
a fixed chuck engaged to the housing and being operationally engaged to the drive linkage, the fixed chuck comprising a square shaft and a pin, the pin being engaged to and extending perpendicularly from the square shaft, the pin being spring loaded such that the pin is selectively depressible into a recess extending into the square shaft;
a tool selectively engageable to the fixed chuck, the tool being configured for tooling sheet metal, such that the motor is positioned for actuating the tool via the drive linkage and the shaft, wherein the tool is configured for effecting tooling of the sheet metal, the tool being one of a plurality of tools, each tool of the plurality of tools having a respective metal working function such that the plurality of tools comprises tools having a variety of metal working functions, the plurality of tools comprising:
an adjustable chucking device wherein the adjustable chucking device is configured for engaging a respective one of a plurality of bits,
a crimping device, the crimping device comprising a rotation translator configured for translating rotation of the fixed chuck into counter rotation of a pair of crimper rods, wherein the crimping device is configured for crimping the sheet metal,
a snipping device, the snipping device comprising a rotation translator configured for translating rotation of the fixed chuck into counter movement of a pair of shears, wherein the snipping device is configured for snipping the sheet metal,
a notching device, the notching device comprising a rotation translator configured for translating rotation of the fixed chuck into counter movement of a pair of notching arms, wherein the notching device is configured for notching the sheet metal, and
a release head selectively engageable to the fixed chuck, wherein the release head is configured for selectively engaging a hexagonal shaft of an implement;
a knob engaged to the tool, the knob being spring loaded such that the knob is configured for selectively depressing such that the knob pushes the pin into the recess allowing the tool to be removed from the fixed chuck; and
a torque selector rotationally engaged to the housing and being operationally engaged to the motor and the drive linkage, wherein the torque selector is configured for rotating for selecting a torque applied by the motor to the drive linkage.
